(19) United States
(12) Patent Application Publication
(10) Pub. No.: US 2009/0317282 A1
(43) Pub. Date: Dec. 24, 2009

(54) METHOD FOR MANUFACTURING POROUS BODY

(75) Inventors: Hideo Nakajima, Osaka (JP); Takuya Ide, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LOTUS ALLOY CO., LTD., Osaka-shi, Osaka (JP)

(21) Appl. No.: 12/307,657

(22) PCT Filed: Jun. 26, 2007
(86) PCT No.: PCT/JP2007/062769

§ 371 Date: Jan. 6, 2009

(30) Foreign Application Priority Data
Jul. 6, 2006 (JP) 2006-213837

(51) Int. Cl. B29C 67/20; C22C 38/00; C22C 23/00; C22C 9/00; C22C 21/00; C01B 33/02; B22D 27/00

(52) U.S. Cl. 420/8; 264/42; 420/402; 420/469; 420/528; 423/349; 164/55.1

(57) ABSTRACT

The present invention provides a process for producing a porous body which comprises dispersing a gas-forming compound in a molten porous body-forming material, and then solidifying the molten material. With this process, the present invention enables manufacture of high quality and highly uniform porous bodies even under an atmospheric pressure, without requiring high pressure ambience.

### TECHNICAL FIELD

The present invention relates to a process for producing a porous body.

### BACKGROUND ART

As a porous body production method, a method for producing porous bodies with control over pore orientation, pore size, porosity etc. has been known. For example, according to one disclosed art, a mixed gas obtained by adding an inactive gas such as argon, helium, etc. to hydrogen, nitrogen, oxygen etc. is dissolved in a molten metal material under pressure, and then porous bodies are formed with control over temperature, pressure, solidification rate by cooling etc. (see Patent Document 1, 2 etc.)

However, because this method is incapable of controlling a gas bubble generation nuclei that is necessary for pore growth, the nuclei formation becomes uneven; therefore, the pores produced become uneven. Moreover, since the gas is dissolved in a molten metal under pressure, this production method must be performed in a pressure vessel, which requires a complicated and unsafe operation. Furthermore, control over porosity, pore size etc. requires control over ambient pressure, and therefore, it is necessary to use a high pressure container resistant to high pressure during the melting and casting processes. Particularly, to obtain a porous body having fine, even pores, manufacturing must be performed under relatively high pressure. Therefore, a large-scale, expensive apparatus is required, which is not suitable for mass production.

In another known method for producing a porous body, a gas ionized to a plasma state is dissolved into a molten raw material, and the material is then solidified (see Patent Document 3). However, this method, in which the gas ionized to the plasma state is dissolved into a molten material using an ion accelerator, is applicable to small amounts and small-scale production, but cannot be used for large amounts and large-scale production.

(Patent Document 1) International Publication No. WO01/004367

### (Patent Document 2) Japanese Unexamined Patent Publication No. 2000-239760

### (Patent Document 3) Japanese Unexamined Patent Publication No. 2003-200253

### DISCLOSURE OF THE INVENTION

### Problem to be Solved by the Invention

The present invention was made in view of the above-described existing problem of known art. A major object of the present invention is to provide a porous body production method that ensures excellent quality and evenness of the resulting porous body, and that uses a process which can be performed even under atmospheric pressure, without requiring high pressure.

### Means for Solving the Problem

The inventors of the present invention conducted an intensive study to attain the foregoing object, and found a method of dispersing a specific gas-forming compound in a molten raw material, and then solidifying the material. In this method, a gas-forming compound is decomposed to form an atomic gas and other components; said other components form a gas bubble generating nuclei in the molten raw material, resulting in the formation of gas bubbles in the molten raw material. The gas dissolved to super-saturation in the solid phase side at a solid-liquid interface is diffused to aggregate into the gas bubbles, thereby growing the gas bubbles into pores. The inventors further found that the method utilizing such a phenomenon does not require a high-pressure atmosphere, and is capable of producing a high-quality porous body even under atmospheric pressure, with control over porosity, pore size or the like. The inventors conducted further research based on the findings, and completed the present invention.

Specifically, the present invention provides the following porous body production method.

1. A process for producing a porous body, comprising dispersing a gas-forming compound in a molten porous body-forming material, and then solidifying the molten material.
2. The process according to Item 1, wherein the porous body-forming material has a gas solubility that is smaller in a solid phase than in a liquid phase.
3. The process according to Item 2, wherein the porous body-forming material is magnesium, aluminum, titanium, chromium, manganese, iron, cobalt, nickel, copper, zirconium, molybdenum, palladium, silver, hafnium, tungsten, tantalum, platinum, gold, lead, uranium, beryllium, an alloy containing at least one member of the foregoing metals, an intermetallic compound containing at least one member of the foregoing metals, silicon, or germanium.
4. The process according to Item 1, wherein the gas-forming compound is a compound which generates by thermal decomposition at least one kind of gas selected from the group consisting of hydrogen, nitrogen, oxygen, H₂O, carbon monoxide, and carbon dioxide.
5. The process according to any one of Items 1 to 4, wherein the gas-forming compound is at least one compound selected from the group consisting of TiH₂, MgH₂, ZrH₂, Fe₄N, TiN, Mn₄N, CrN, Mo₂N, Ca(OH)₂, Cu₂O, B₂O₃, CaCO₃, SrCO₃, MgCO₃, BaCO₃ and NaHCO₃.
6. The process according to any one of Items 1 to 5, wherein the gas-forming compound is added to the molten porous body-forming material by adding the gas-forming compound to the molten material; supplying the gas-forming compound in a container for the molten material beforehand; supplying the gas-forming compound in a mold beforehand; or supplying the gas-forming compound to the porous body-forming material before the material is melted.
7. The process according to any one of Items 1 to 6, wherein the porous body is produced using a mold casting method, a continuous casting method, a floating zone melting method, or a laser•arc beam melting method.
8. The process according to any one of Items 1 to 7, wherein, before the porous body-forming material is melted, the material is degassed by being retained in an airtight container under reduced pressure at a temperature less than a melting point of the material.
9. A porous body produced by the process according to any one of Items 1 to 8.

In the porous body production method of the present invention, first, a porous body-forming material is melted, and a gas-forming compound is dispersed in the molten material. This causes the gas-forming compound to be decomposed in the high temperature molten material to generate a gas component, and the largest part of the gas component is assumed to be dissociated into ions, atoms or the like in the molten material. Next, when the molten material is cooled and solidified, the excess gas component over the solubility limit generates a molecular gas. Simultaneously, other components resulting from the thermal decomposition of the gas-forming compound serve as a gas bubble generating nuclei, and generate gas bubbles. Then, the gas component dissolved to super-saturation in the solid phase side at a solid-liquid interface is diffused to aggregate into the gas bubbles, thereby growing the gas bubbles into pores.

This reaction is expressed by the following reaction formula, where MHx represents a gas-forming compound.

MHx→M+xH

xH→yH (the soluble component in the solid phase)+zH₂ (gas bubble)

(on condition that x=y+2z)

The gas bubbles generated from the super-saturated gas component as a result of the foregoing reaction are diffused in the pores, and continuously grow at the solid-liquid interface of the molten raw material in the direction in which the cooling proceeds. As a result, a porous body is formed. Also, when other gas components form gas bubbles, gas bubble formation can be expressed not only by a single reaction step, but also by two or more reaction steps.

### EFFECT OF THE INVENTION

The porous body production method of the present invention ensures excellent quality of the resulting porous body with control over porosity, pore size, pore form or the like, and the method can be performed even under atmospheric pressure, without requiring high pressure. According to the present invention, porous body production can be performed in a simpler way, and the apparatus structure, apparatus configuration, and pore controlling technique can be simplified.

Accordingly, the porous body production method of the present invention allows for large-amount and large-scale production of porous bodies of high quality and evenness. The present invention thus enables the mass production of high-quality porous bodies.

### BRIEF DESCRIPTION OF THE DRAWINGS

FIG. 1 is a cross-sectional view schematically showing an example of an apparatus for producing a porous body 101 used for the present invention.

FIG. 2 is a schematic view showing an example of a vertical-type apparatus for producing a porous continuous body 104 using continuous casting.

FIG. 3 is a schematic view showing an example of a horizontal-type apparatus for producing a porous continuous body 104 using continuous casting, and pulling out the porous continuous body 104 in the horizontal direction.

FIG. 4 is a schematic view showing an example of a horizontal-type apparatus for producing a porous continuous body 104 using a floating zone melting method, and discharging the porous continuous body 104 in the horizontal direction.

FIG. 5 is a schematic view showing an example of an apparatus for producing a porous continuous body 104 using a laser•arc beam melting method.

FIG. 6 is a cross-sectional view schematically showing an example of a means for adding a gas-forming compound 102 used in the apparatuses of FIG. 1 to FIG. 3.

FIG. 7 is a cross-sectional view schematically showing another example of a means for adding a gas-forming compound 102 used in the apparatus of FIG. 3.

FIG. 8 is a cut-out perspective view schematically showing a porous body produced by a method according to the present invention.

FIG. 9 is an optical microscope image showing a cross-section of a porous body obtained in Example 1.

FIG. 10 is an optical microscope image showing a cross-section of a porous body obtained in Example 2.

FIG. 11 is an optical microscope image showing a cross-section of a porous body obtained in Example 3.

FIG. 12 is an optical microscope image showing a cross-section of a porous body obtained in Example 4.

FIG. 13 is an optical microscope image showing a cross-section of a porous body obtained in Example 5.

FIG. 14 is a graph showing the relationship between the amount of titanium hydride and the porosity, for each of the porous bodies obtained in Examples 1 to 5.

FIG. 15 is a graph showing the relationship between the addition amount of titanium hydride and the pore size, for each of the porous bodies obtained in Examples 1 to 5.

FIG. 16 is an optical microscope image showing a cross-section of a porous body obtained in Example 6.

FIG. 17 is a graph showing the relationship between the amount of titanium hydride, and the pore size and the porosity, for a porous body obtained in Example 6.

FIG. 18 is an optical microscope image showing a cross-section of a porous body obtained in Example 7.

FIG. 19 is a graph showing the relationship between the pressure of argon gas, and the porosity and pore size, for a porous body obtained in Example 7.

FIG. 20 is a graph showing the aluminum porous body porosity for each of the gas-forming compounds used in Example 8.

FIG. 21 is a drawing schematically showing an iron rod used as a raw material in Example 9.

FIG. 22 is a drawing schematically showing the method of Example 9.

FIG. 23 is a graph showing the relationship between the pressure of argon gas and the porosity, for a porous body obtained in Example 12.

FIG. 24 is a graph showing the relationship between the pressure of argon gas and the pore size, for a porous body obtained in Example 12.

### REFERENCE NUMERALS

1. Heating Unit Container
2. Container Cover
3. Heat-Retention Adjusting Unit Container
4. Solidification Adjusting Unit Container
5. Cooling Unit Container
6. Crucible
7. Crucible Stopper
8. Funnel
9. Mold
10. Cooling Unit
11. Driving Unit
12. Continuous Casting Mold
13. Induction Heating Coil
14. Raw Material Supplying Unit
15. Porous Body Outlet
16. Auxiliary Heating Coil
17. Auxiliary Cooling Unit
18. Pinch Roll
19. Non-Porous Raw Material
20. Junction between Non-Porous Raw Material and Porous Body
21. Heat-Retention Container
22. Compound Supplying Unit
23. Compound Stirring Unit
24. Coolant Water Inlet
25. Coolant Water Outlet
26. Gas Inlet
27. Gas Outlet
28. Cathode
29. Anode
30. Plasma-Jet Unit
31. Needle Valve
32. Inlet
33. Jet Flow Path for Compound
34. Laser Beam Source or Arc Beam Source
100. Molten Raw Material
101. Porous Separate Body
102. Gas-Forming Compound
103. Pore
104. Porous Continuous Body
105. Gas Bubble Generating Nuclei
106. Plasma-Jet Heat
107. Laser or Arc Beam
200. Coolant Water
300. Argon

### BEST MODE FOR CARRYING OUT THE INVENTION

The porous body production method according to the present invention is more specifically explained below.

### (1) POROUS BODY-FORMING MATERIAL

In the present invention, any substance may be used as a porous body-forming material, as long as it has gas solubility in the molten state, and the gas solubility is greater in the liquid phase, and smaller in the solid phase. More specifically, in the present invention, the porous body-forming material is not particularly limited as long as its gas solubility is smaller in the solid phase than in the liquid phase.

Examples of such porous body-forming materials include metals, semimetals, and intermetallic compounds. Examples of metals include magnesium, aluminum, titanium, chromium, manganese, iron, cobalt, nickel, copper, zirconium, molybdenum, palladium, silver, hafnium, tungsten, tantalum, platinum, gold, lead, uranium, beryllium, and alloys containing at least one member of these metals. Intermetallic compounds containing at least one member of the foregoing metals may also be used. Examples of semimetals include silicon and germanium.

### (2) GAS-FORMING COMPOUND

The present invention uses, as a gas-forming compound, a compound that generates a gas by a thermal decomposition. A particularly preferred compound to be used as a gas-forming compound is a substance whose thermal decomposition temperature is about 300° C. or higher, and is up to a temperature of about 500° C. higher than the melting point of the porous body-forming material to be used. Examples of gases generated by the thermal decomposition include hydrogen, nitrogen, oxygen, H₂O, carbon monoxide, and carbon dioxide.

Examples of such a gas-forming compound include hydrides, nitrides, oxides, hydroxides and carbonates. Examples of hydrides include TiH₂, MgH₂, and ZrH₂, and thermal decomposition of these compounds generates hydrogen. Examples of nitrides include Fe₄N, TiN, Mn₄N, CrN, and Mo₂N, and thermal decomposition of these compounds generates nitrogen. Examples of oxides include Cu₂O and B₂O₃, and thermal decomposition of these compounds generates oxygen. A typical example of a hydroxide is Ca(OH)₂; thermal decomposition of the compound generates moisture, and further generates hydrogen as the thermal decomposition proceeds. Examples of carbonates include CaCO₃, SrCO₃, MgCO₃, BaCO₃, and NaHCO₃; thermal decomposition of these compounds generates carbon monoxide, carbon dioxide, moisture, hydrogen, etc.

The above-mentioned gas-forming compound is appropriately selected from materials that have large solubility of the generated gas in the liquid phase, and small solubility in the solid phase.

The followings are examples of preferable combinations of a porous body-forming material and a gas-forming compound.

TABLE 1

| | GAS-FORMING |
|---|---|
| POROUS BODY-FORMING MATERIAL | COMPOUND |
| COPPER | TiH₂, ZrH₂ |
| ALUMINUM | CaCO₃ |
| | Ca(OH)₂ |
| | NaHCO₃ |
| | TiH₂ |
| | ZrH₂ |
| | BaCO₃ |
| | MgCO₃ |
| MAGNESIUM OR MAGNESIUM ALLOY | MgH₂ |
| | MgCO₃ |
| IRON | TiH₂ |
| | ZrH₂ |
| | Fe₄N |
| | CrN |
| | Mn₄N |
| | Mo₂N |
| | CaCO₃ |
| | SrCO₃ |
| | BaCO₃ |
| | Cu₂O |
| | B₂O₃ |
| | TiN |
| SILICON | TiH₂ |
| | ZrH₂ |
| | Ca(OH)₂ |
| | SrCO₃ |

### (3) AMOUNT OF MATERIAL

The proportion of the porous body-forming material and the gas-forming compound is determined according to the porosity, pore size or the like of the target porous body. Generally, a shortage of the gas-forming compound causes insufficient pore production; however, an excessive amount of the gas-forming compound may leave unreacted residual gas-forming compounds after the production. For example, in the production of a porous body using the method of placing a pellet-form, gas-forming compound in a mold, the amount of the gas-forming compound is preferably 0.01 to 10 parts by weight, more preferably 0.05 to 5 parts by weight, based on 100 parts by weight of the porous body-forming material.

### (4) POROUS BODY PRODUCTION PROCESS

The porous body production process according to the present invention is not particularly limited, and various methods, such as mold casting method, continuous casting method, a floating zone melting method, a laser•arc beam melting method etc. may be used. In mold casting method, a raw material melted in a crucible is poured into a mold. In continuous casting method, a molten raw material is cooled as it passes through a cooling unit, and the resulting solidified bodies are continuously pulled out. In the floating zone melting method, a raw material is partially melted while moving the material, and then the molten metal portion is sequentially cooled. In the laser•arc beam melting method, a raw material is partially melted using a laser beam, an arc beam etc. by moving either the material or the beam. In the methods above, examples of the continuous casting method include a board production method, in which a molten raw material is continuously formed into a board using a rotation drum; and a wire production method, in which a molten raw material is extracted while being formed into a wire.

### (i) Melting Step:

In the present invention, the porous body-forming material is first melted using the foregoing various methods. A gas-forming compound is then dispersed in the molten material.

The method for melting the material is not particularly limited, and may be appropriately selected from various known heating methods according to the production method used. In one typical method, the porous body-forming material is melted by a heating process using a high-frequency induction coil. Any other heating methods may also be appropriately used according to the type of the raw material and manufacturing processes. For example, plasma arc heating, gas torch heating, laser beam heating, halogen lamp heating, xenon lamp heating or the like method can be used for a small-scale continuous casting apparatus. For example, heating using an electric resistance or the like can be used to avoid the influence of a high frequency radiation.

The heating temperature must be higher than the melting point of the raw material. There is no restriction on the upper limit of the temperature. The temperature is generally up to a temperature about 500° C. higher than the melting point of the raw material, but may be higher than that.

The pore size may be varied by changing the melting temperature. Generally, an increase in the melting temperature also tends to increase the pore size. For example, in the method of melting aluminum in a vacuum, and then solidifying the molten aluminum in a mold supplied with Ca(OH)₂ that serves as a gas-forming compound, when the temperature of the molten aluminum in the crucible is increased from 750° C. to 1,050° C., it tends to increase only the pore size, while causing little change in the porosity. This is presumably because the increase in temperature promotes the diffusion of gas molecules, thereby facilitating pore growth, or because the increase in temperature promotes the thermal decomposition reaction of the gas-forming compound.

The method of adding a gas-forming compound to a molten raw material is not particularly limited, and an appropriate method can be selected according to the porous body production method. Examples of this technique include a method of adding a gas-forming compound to a molten raw material; a method of supplying a gas-forming compound inside a container for molten raw material beforehand; a method of supplying a gas-forming compound inside a mold beforehand; and a method of supplying a gas-forming compound to the surface or inside of a raw material before the material is melted.

Examples of the methods of adding a gas-forming compound to a molten raw material include a method of directly adding the gas-forming compound in the form of powder, pellet, or the like to the molten raw material; a method of spraying the gas-forming compound in the form of powder or the like to the molten raw material using a nozzle or the like; and a method of continuously applying the gas-forming compound to the surface of a rotation drum for use in a board production method, thereby supplying the gas-forming compound to the molten raw material. Examples of the methods of spraying a gas-forming compound using a nozzle or the like include a method of spraying the gas-forming compound, either solely or with an inactive gas such as argon, helium, neon or krypton, to the molten raw material in a container for molten raw material; and a method of spraying the gas-forming compound to the molten raw material moving from a container for molten raw material to a cooling unit in a continuous casting method. A typical example of the floating zone melting method is a method of spraying the gas-forming compound to the molten part of the raw material.

The methods of supplying a gas-forming compound inside the container for molten raw material beforehand may be carried out by supplying the gas-forming compound in a container for molten raw material such as a crucible or the like, for example, by applying the gas-forming compound to the inner side surface or the bottom surface of the container or by placing the gas-forming compound in the form of powder, pellet, or the like in the container for molten raw material, so that the gas-forming compound disperses when the material is melted by heating. This method is useful for a mold casting method, or a continuous casting method.

The methods of supplying a gas-forming compound to the inside of the mold may be carried out, for example, by applying the gas-forming compound to the inner side surface, the bottom surface etc. of the mold; or by supplying the gas-forming compound in the form of powder, pellet, or the like in the mold beforehand. In this case, the gas-forming compound may be mixed with a mold-releasing agent or the like. Compared with the method of supplying a gas-forming compound in a container for molten raw material, this method is more advantageous because it causes less leakage of the generated gas, improving efficiency in the porous body production.

The method of applying a gas-forming compound to a raw material before the material is melted may be carried out by applying the gas-forming compound to a part or the whole of the surface of the raw material; or by forming a void portion in a part of the raw material and filling the void portion with the gas-forming compound. This method is useful for a floating zone melting method, laser•arc beam melting method or the like.

In this step, the gas-forming compound added to the molten raw material disperses in the molten raw material, and is decomposed into a gas component and other components. Most of the gas component exists as ions or atoms in the molten raw material.

After the gas-forming compound is added to the molten material, the gas-forming compound must be sufficiently dispersed in the molten raw material. To ensure sufficient dispersion, as necessary, the molten raw material may be stirred by spraying an inactive gas such as argon, helium, neon, or krypton into the molten raw material or by mechanical stirring.

### (ii) Cooling Step:

After dispersing a gas-forming compound in a molten raw material in the melting step, the molten raw material is cooled and solidified.

In this step, among the gas components which exist as ions or atoms, the portion exceeding the solid-solubility limit forms a molecular gas. Further, other atoms dissociated from the gas-forming compound form a new compound within the molten raw material. The new compound thus formed serves as a gas bubble generating nuclei that precipitates the above-mentioned molecular gas within the molten raw material, and thereby forms gas bubbles. The gas atoms that dissolved to super-saturation in the solid phase side at the solid-liquid interface are diffused to aggregate in the gas bubbles, thereby growing the gas bubbles into pores. The pores usually grow in the direction where the solidification proceeds. For example, when the solidification proceeds from the bottom to the upper part in one direction, the gas bubbles also grow linearly from the bottom to the upper part in one direction. As such, a porous body having micropores aligned in one direction is produced.

The cooling method is not particularly limited, and any arbitrary method can be appropriately adopted according to the production method. For example, cooling may be carried out by pouring a molten raw material in a mold, and cooling the bottom of the mold with water so as to solidify the molten raw material. This method allows production of a porous separate body having pores that linearly grow from the lower to upper surface of the porous body in one direction. Further, in the case of using a mold having a cylindrical side surface, when the solidification is performed by cooling the mold from the side surface, the pore growth proceeds from the circumference of the mold to the center, forming a porous separate body having radial pores.

Further, with a method using a mold for continuous casting in which a molten raw material is cooled by passing it through a cooling unit and the resulting solidified bodies are continuously extracted, it becomes possible to produce a round-bar porous continuous body, a platy porous continuous body, or the like. This method allows for the production of a porous body having pores linearly extending in a direction parallel to the moving direction of the solidified bodies.

Furthermore, in the method of carrying out auxiliary cooling, for example, by continuously spraying water to the porous continuous body being extracted, it is possible to generate a temperature gradient on the porous continuous body, which is continuously solidified while being extracted, between the position of the auxiliary cooling unit and the position of the continuous casting mold, by controlling the temperature in the auxiliary cooling. Accordingly, the continuously growing pores can be aligned in the longitudinal direction of the porous body. In the casting method, which is carried out in an airtight container under high pressure or reduced pressure using an inactive gas, the secondary auxiliary cooling can be performed with cooled inactive gas instead of the spraying of the coolant water.

The cooling rate is not particularly limited, and may be set appropriately according to the target pore size, porosity, pore form, etc. The pore size tends to decrease with an increase in the cooling rate. The cooling rate is preferably about 1° C./sec to about 500° C./sec., and more preferably about 5° C./sec. to about 100° C./sec.

(iii) Atmosphere in Melting Step and Cooling Step:

An atmosphere in the melting step and cooling step is not particularly limited. For example, the melting step may be carried out in a various atmosphere, such as in the atmosphere of the air or in the atmosphere of inactive gas (argon, helium, neon, or krypton), hydrogen, nitrogen, oxygen, carbon monoxide, carbon dioxide or moisture. The pressure is also not particularly limited, and may be selected from a wide range, for example, about 10⁻⁵ Pa to 10 MPa.

In the process of the present invention, a gas-forming compound is added to a molten raw material, and the gas generated by the thermal decomposition reaction of the gas-forming compound is dissolved in the raw material. Therefore, the melting step and the cooling step in this process can be carried out in the air, i.e., not in a closed pressure vessel, and are therefore significantly advantageous.

Moreover, since inactive gases such as argon or helium are barely dissolved in a molten raw material, it is possible to control porosity, pore size or the like by carrying out the melting and/or the cooling step under inactive gas atmosphere and controlling the pressure of the inactive gas. Generally, as the pressure of the inactive gas increases, the porosity tends to decrease, and the average pore size tends to decrease. This principle is not clearly understood. It is, however, assumed that the increase in pressure decreases the volume of the pores and further suppresses the thermal decomposition reaction of the compound, resulting in insufficient dissociation of the compound in the molten metal.

For example, in the production of 200 g porous copper in a mold having a 0.25 g titanium hydride (TiH₂) pellet, an increase in argon pressure from 0.1 MPa to 0.5 MPa decreases the porosity from 60% to 10%, and also decreases the average pore size from 800 μm to 200 μm. Further, in the production of 20 g porous silicon in a mold having a 1.0 g titanium hydride (TiH₂) pellet, an increase in argon pressure from 0.1 MPa to 1.5 MPa decreases the porosity from 30% to 10%, and also decreases the average pore size from 150 μm to 100 μm.

If the raw material is easily oxidizable, the melting and cooling step may be carried out under, for example, reduced pressure, such as in a vacuum, or in the inactive gas atmosphere. As described above, the porosity or the average pore size can be decreased by increasing the pressure of the inactive gas. Inversely, the porosity and average pore size can be increased using reduced pressure such as a vacuum ambience.

### (iv) Degasification Step

In the present invention, before melting a porous body-forming material, the degasification of the porous body-forming material may be performed, as necessary, by storing the porous body-forming material in a container, and keeping the porous body-forming material in the container under reduced pressure at a temperature less than the melting point of the material. This control decreases the amount of impurities in the porous body-forming material, thereby increasing the quality of the final porous body product.

The condition of reduced pressure in this step varies depending on the type of a raw material, the impurities (oxygen, nitrogen, hydrogen etc.) to be removed from the raw material or the like; however, the pressure is generally not more than about 7 Pa, preferably falls within a range about from 7 Pa to 7×10⁻⁴ Pa. If the pressure reduction is not sufficient, the residual impurities may reduce the corrosion resistance, mechanical strength, toughness etc. of the porous body. Conversely, if the pressure reduction is excessive, though the performance of the porous body is slightly improved, the apparatus production cost and operation cost inevitably increase, which is not desirable.

In the degasification step, the raw material is kept at a temperature within a range between room temperature to a temperature less than the melting point of the raw material, more preferably, at a temperature of about 50 to 200° C. lower than the melting point.

The retention time in the degasification step is determined according to the type or the amount of the impurities contained in the raw material, the desired degree of the degasification etc.

### (5) EMBODIMENTS

The following describes specific embodiments of a production method of the present invention.

### (i) Embodiment 1

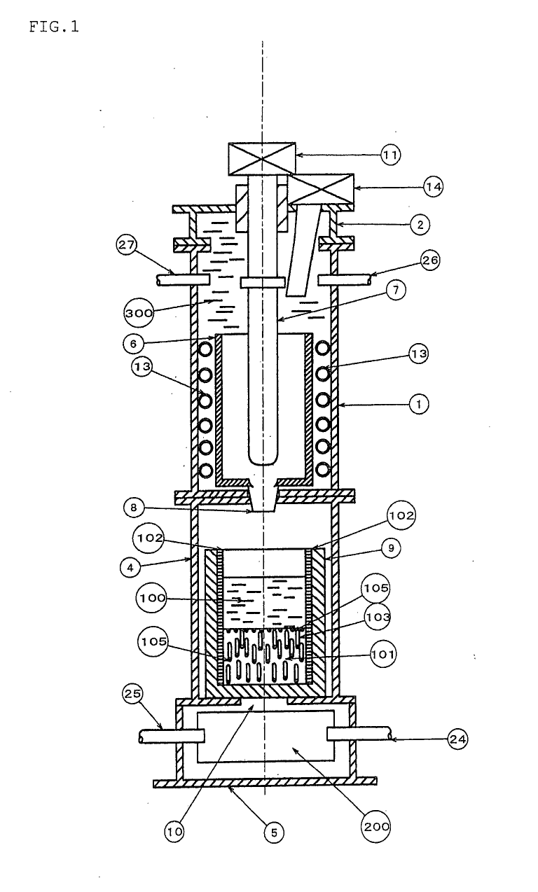

FIG. 1 is a cross-sectional view schematically showing an example of an apparatus for producing a porous body 101 used for the present invention. The apparatus of FIG. 1 includes a heating unit container 1 for heating and melting a porous body-forming material; and, vertically disposed, a solidification adjusting unit container 4 and a cooling unit container 5 for cooling and solidifying a molten raw material 100. The heating unit container 1 includes a crucible 6, a crucible stopper 7, an induction heating coil 13, a gas inlet 26, a gas outlet 27, and a funnel 8. Placed above the heating unit container 1 are a container cover 2, and a driving unit 11 for pulling up the crucible stopper 7.

First, the crucible stopper 7 is lowered to the closing position to supply the raw material into the crucible 6, and the container cover 2 is placed to close the apparatus. The pressure is reduced through the gas outlet 27 using a vacuum pump. Next, the raw material is heated by an induction heating coil 13 to a predetermined temperature to reduce the impurities, such as oxygen, from the raw material, thereby obtaining a raw material 100.

Then, argon 300 is injected from the gas inlet 26, and the heating unit container 1 and the solidification adjusting unit container 4 are kept under a predetermined ambient pressure.

When the temperature of the molten raw material 100 is increased to a predetermined temperature and the predetermined retention time elapses, the crucible stopper 7 is pulled upward by the driving unit 11, and the molten raw material 100 passes through the funnel 8, and is poured in the mold 9 below. A mixture of a gas-forming compound 102 and a mold-releasing agent is applied to the inner surface of the mold 9 in advance. The molten raw material 100 is then accumulated upward from the bottom of the mold 9, and the mixture of the gas-forming compound 102 and the mold-releasing agent previously applied to the inner surface of the mold 9 is dispersed in the molten raw material 100. As a result, the gas-forming compound is diffused and decomposed to generate a gas and form a gas bubble generating nuclei 105.

At the same time, the coolant water 200 is supplied from the coolant water inlet 24. The coolant water 200 cools the upper surface of the cooling unit 10 and flows out from the coolant water outlet 25. The bottom of the mold 9 above the cooling unit is thus cooled, gradually cooling the molten raw material 100 from the bottom portion of the mold 9. When the material is solidified, generation of a gas and formation of the gas bubble generating nuclei 105 occur at the same time in the solid phase at the solid-liquid interface, thereby growing gas bubbles. The generation and growth of gas bubbles are repeated to obtain a porous body 101 having pores 103, each of which extends in a direction, from the lower to the upper part of the apparatus.

### (ii) Embodiment 2

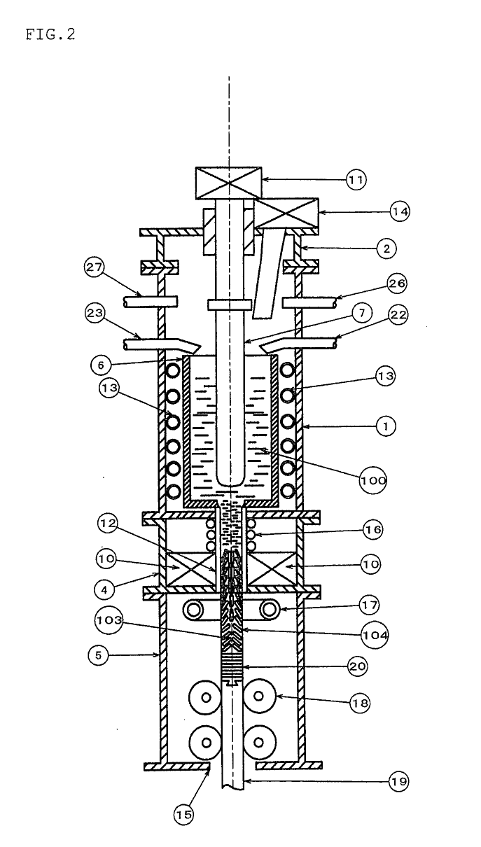

FIG. 2 is a schematic view showing an example of a vertical-type apparatus for producing a porous continuous body 104 using continuous casting method. The apparatus of FIG. 2 includes a heating unit container 1 for heating and melting a porous body-forming material; and, vertically disposed, a solidification adjusting unit container 4 and a cooling unit container 5. The molten raw material 100 that has passed through the continuous casting mold 12 moves downward while being cooled, and is solidified to form a porous continuous body 104. In the cooling unit container 5, the auxiliary cooling unit 17 is constantly cooling the material with the coolant water 200 to increase the temperature gradient, so as to align the pores 103 continuously growing inside the porous continuous body 104 in one direction, while the porous continuous bodies 104 are pulled out downward.

In the raw material supplying unit 14 disposed above the container cover 2, a raw material having been subjected to degasification is stored. The crucible stopper 7 is lowered by the driving unit 11 to cover the entrance of the continuous casting mold 12, so that the crucible 6 is kept closed. Next, a predetermined amount of raw material is dropped into the crucible 6 by the raw material supplying unit 14. An inactive gas is injected from the gas inlet 26, and electricity passes through the induction heating coil 13 to heat the raw material while keeping the ambient pressure at a predetermined level. This apparatus adopts the same heating method as that of the apparatus of FIG. 1. After the raw material is melted and the temperature thereof reaches a predetermined value, the gas-forming compound 102 is added to the molten raw material 100 through a pipy compound supplying unit 22. The inactive gas flows into the molten material 100 from the stirring unit 23, thereby stirring the molten raw material 100.

In the apparatus of FIG. 2, the molten raw material 100 is cooled and begins to be solidified in the continuous casting mold 12 below the crucible 6. In this apparatus, the temperature gradient can be controlled by adjusting the temperatures of the auxiliary heating coil 16, the cooling unit 10 that indirectly uses the coolant water 200, and the auxiliary cooling unit 17 that directly uses the coolant water 200, thereby adjusting the porosity, pore size, pore orientation, etc. of the resulting pore 103. As a result, a lengthy porous continuous body 104 is obtained.

### (iii) Embodiment 3

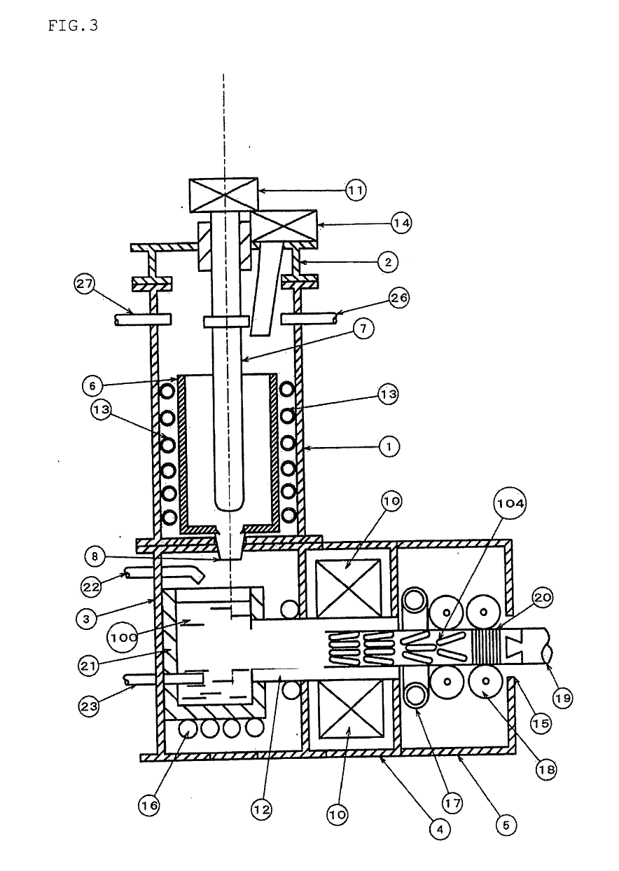

FIG. 3 is a schematic view showing an example of a horizontal-type apparatus for producing a porous continuous body 104 using continuous casting method, and pulling out the porous continuous body 104 in the horizontal direction. The apparatus of FIG. 3 includes a heating unit container 1 and a heat-retention unit container 3, which are vertically disposed; and, horizontally disposed, a solidification adjusting unit container 4 and a cooling unit container 5 having an auxiliary cooling unit 17. This FIG. 3 apparatus adopts the same heating method as that of the apparatuses of FIG. 1 and FIG. 2. The gas-forming compound 102 is added to the molten raw material 100 in the heat-retention container 21 inside the heat-retention adjusting unit container 3 via the compound supplying unit 22. At this time, by supplying an inactive gas via a stirring unit 23 and thereby stirring the molten raw material, the dissociation of the gas-forming compound 102 is facilitated.

After subsequent cooling and solidification of the material, the porous continuous body 104 is continuously pulled out from the porous body outlet 15. In this manner, a lengthy porous continuous body 104 is obtained.

### (iv) Embodiment 4

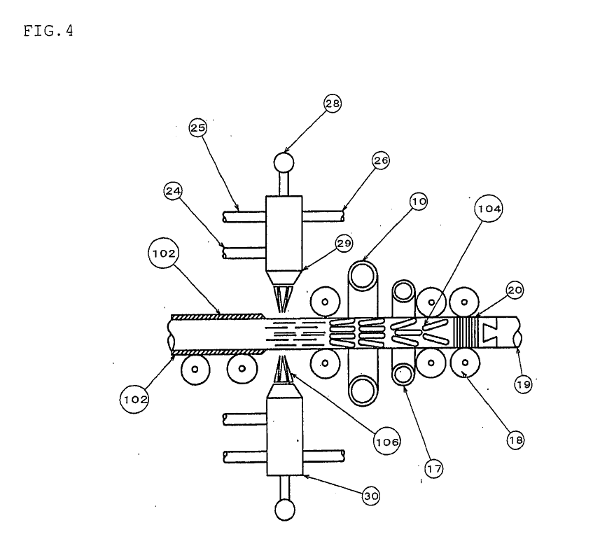

FIG. 4 is a schematic view showing an example of a horizontal-type apparatus for producing a porous continuous body 104, which uses a floating zone melting method, and pulls out the porous continuous body 104 in the horizontal direction. In the apparatus of FIG. 4, the gas-forming compound 102 is applied to a surface of a lengthy raw material, such as a lengthy steel plate or a round-bar raw material. After being dried, the material is disposed above the pinch roll 18, and then moved by rotating the pinch roll 18 while adjusting the material position in the horizontal direction.

To melt the raw material, the apparatus of FIG. 4 adopts a heating method in which the raw material is continuously heated by a plasma-jet unit 30 using arc-discharge plasma. The plasma-jet unit 30 includes a cathode 28, an anode 29, a gas inlet 26, a coolant water inlet 24 and a coolant water outlet 25. The plasma-jet heat 106 is ejected, together with an inactive gas 300 such as argon, from the open end of the anode 29, thereby heating and melting the raw material.

With such a method, the raw material is partially melted and the gas-forming compound 102 applied to the surface rapidly undergoes decomposition inside the molten raw material 100. The gas-forming compound generates a gas, and the molten material is then cooled by the cooling unit 10 to be solidified. In the cooling unit 10 and the auxiliary cooling unit 17, the porous continuous body 104 starting to solidify can be cooled directly with coolant water to facilitate solidification. The apparatus of FIG. 4 is capable of producing the lengthy porous continuous body 104 in an arbitrary ambience including an atmospheric ambience, a reduced pressure ambience, or a high pressure ambience.

### (v) Embodiment 5

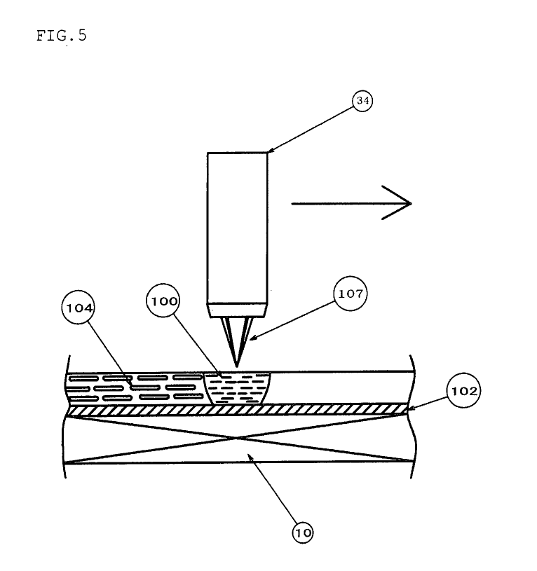

FIG. 5 is a schematic view showing an example of an apparatus for producing a porous continuous body 104 using a laser•arc beam melting method. In this apparatus, a layer of the gas-forming compound 102 is formed on the cooling unit 10, and a lengthy raw material, such as a lengthy steel plate or a round-bar raw material is disposed thereon. The raw material is continuously heated while horizontally moving a laser beam source or an arc beam source 34, so that the raw material is partially melted by the heat of the laser or arc beam 107. In the molten raw material 100 thus obtained, the gas-forming compound 102 is diffused and decomposed to generate gas and forms a gas bubble generating nuclei 105. Thereafter, the molten raw material 100 is cooled and solidified with the movement of the laser beam source or arc beam source 34, thereby forming the porous continuous body 104. At this time, by changing the movement speed of the laser beam source or arc beam source 34, the orientation of the pores can be changed.

### (vi) Embodiment 6

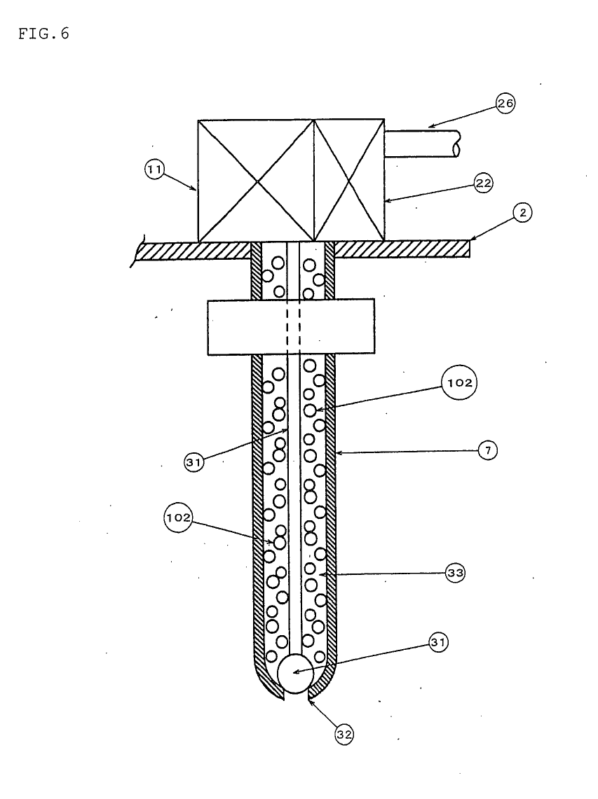

FIG. 6 is a cross-sectional view schematically showing an example of a means for adding a gas-forming compound 102 used in the apparatuses of FIGS. 1 to 3. This means for adding a gas-forming compound uses the crucible stopper 7 as a means for adding the gas-forming compound 102. In this apparatus, a path 33 for flowing the gas-forming compound 102 is provided inside the crucible stopper 7, and an addition inlet 32 is provided on the bottom end of the crucible stopper 7, upon which a needle valve 31 is placed.

In the means for adding a gas-forming compound shown in FIG. 6, a compound supplying unit 22, a gas inlet 26 for injecting an inactive gas, and the head of a needle valve 31 are provided above the crucible stopper 7. The crucible stopper 7 and the needle valve 31 are moved upward by the driving unit 11, and the gas-forming compound 102 is pushed to the bottom of the crucible 6, together with the jet flow of the inactive gas such as argon. When the molten raw material 100 flows from the crucible 6 into the mold 9 or into the continuous casting mold 12, the gas-forming compound 102 is stirred inside the molten raw material 100, and is thereby decomposed to generate a gas. With subsequent cooling and solidification of the molten raw material 100, a porous body 101 or a porous continuous body 104, which have pores 103 extending in one direction, is formed.

### (vii) Embodiment 7

FIG. 7 is a cross-sectional view schematically showing another example of a means for adding a gas-forming compound 102 used in the apparatus of FIG. 3. In this embodiment, the compound supplying unit 22 and the stirring unit 23 are provided at predetermined positions of the continuous casting mold 12. By supplying the jet flow of the gas-forming compound 102 and the inactive gas such as argon into the molten raw material 100, the molten raw material 100 is stirred and the gas-forming compound 102 is dispersed in the molten raw material 100 to generate a gas. Consequently, a porous continuous body 104, which has pores 103 extending in one direction, is formed.

### (6) POROUS BODY

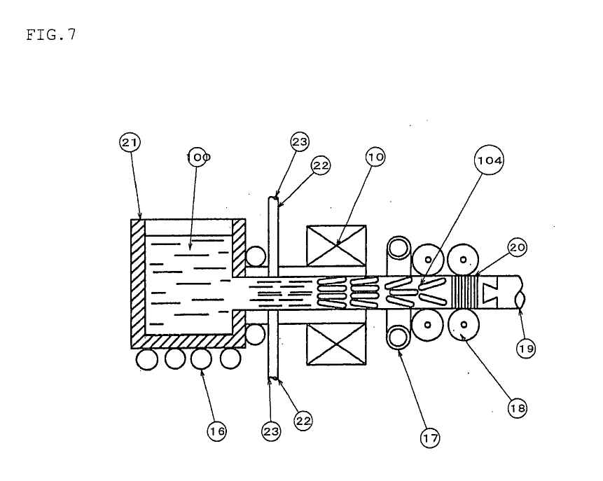

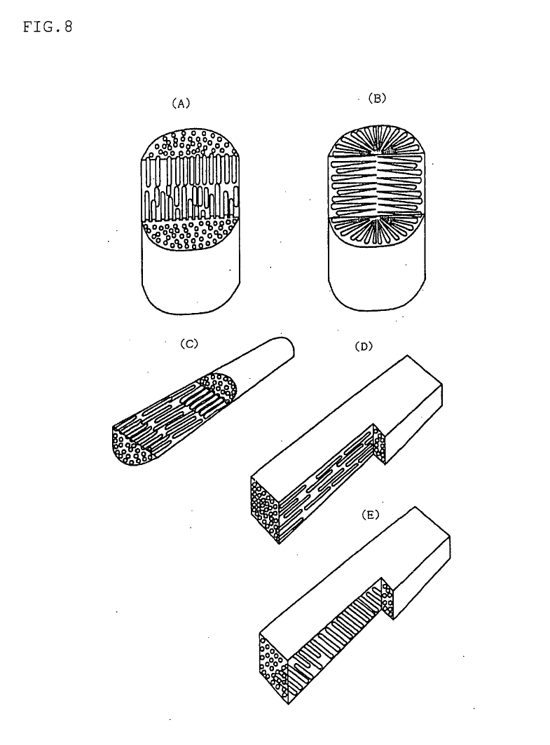

FIG. 8 show partially cut-out perspective views schematically showing porous bodies produced by the methods according to Embodiments 1 to 5.

FIG. 8 (A) is a schematic view showing a porous separate body produced by the apparatus of FIG. 1. The porous separate body has unidirectional pores extending upward from the bottom of the mold. In this porous body, the pore formation can be controlled by selecting an appropriate type of gas-forming compound and adjusting its amount, thereby obtaining a desired pore form.

FIG. 8 (B) is a schematic view showing a porous body obtained by cooling the periphery of the mold 9 using the apparatus of FIG. 1 so that the solidification of the molten material proceeds from the periphery to the center. This porous body has unidirectional pores that extend radially.

FIG. 8 (C) is a schematic view showing a porous body obtained by sequentially solidifying a lengthy bar so that the solidification proceeds backward from the one end of the bar, using the apparatus of any one of FIG. 2 to FIG. 4. This porous body is a porous continuous body having unidirectional pores extending in the longitudinal direction.

FIG. 8 (D) is a schematic view showing a lengthy platy porous continuous body obtained by the same apparatus as that of FIG. 8 (C). This porous body has unidirectional pores extending backward from the one end of the continuous body.

FIG. 8 (E) is a schematic view showing a lengthy platy porous continuous body obtained by the same apparatus as that of FIG. 8 (D). This porous body is solidified by cooling one side of the molten raw material, thereby having unidirectional pores extending from the cooling side to the other side.

The present invention allows arbitrary control of the shapes of pores, porosity etc. by adjusting the type or amount of the gas-forming compound, or the type of the apparatus used, the cooling method etc. The present invention generally produces a porous body about 5 to 5,000 μm in pore size, and about 5 to 75% in porosity.

### Example 1

Using the porous body production apparatus of FIG. 1, a porous body was produced as follows. In the apparatus of FIG. 1, the bottom of the mold 9 is formed of a copper disc, and a peripheral portion of the mold 9 is formed of a cylindrical thin stainless steel plate.

First, titanium hydride (TiH₂), which serves as a gas-forming compound 102, and a mold-releasing agent (a mixture of alumina Al₂O₃ and liquid glass Na₂SiO₃) are applied to the inner side surface of the mold 9, followed by drying. The mold 9 is disposed directly on the upper surface of the cooling unit 10 to increase the cooling effect of the copper disc of the bottom of the mold 9.

Pure copper (99.99%) 105 g was used as a porous body-forming material. The copper was heated by a high frequency induction heating coil 13 in the crucible 6 under a 0.1 MPa argon atmosphere, and kept at 1,300° C.

Next, the molten raw material 100 was poured into the mold 9. As a result, the titanium hydride (TiH₂) previously applied to the inner side surface of the mold 9 is diffused into the molten raw material 100, thereby generating a hydrogen gas. Most of the hydrogen gas was dissociated into hydrogen ion or atoms. In this experiment, 4 g of titanium hydride was used with respect to 105 g of pure copper.

Coolant water was supplied to the cooling unit 10 so as to cool the molten material from the bottom of the mold 9. As a result, the molten material began to be solidified from its bottom portion, and the fine reaction product, which was formed by the thermal decomposition of titanium hydride, served as a gas bubble generating nuclei 105 to generate gas bubbles. As such, unidirectional, uniform pores 103 grew upward as the molten material was solidified, thereby forming a cylindrical copper porous separate body 101.

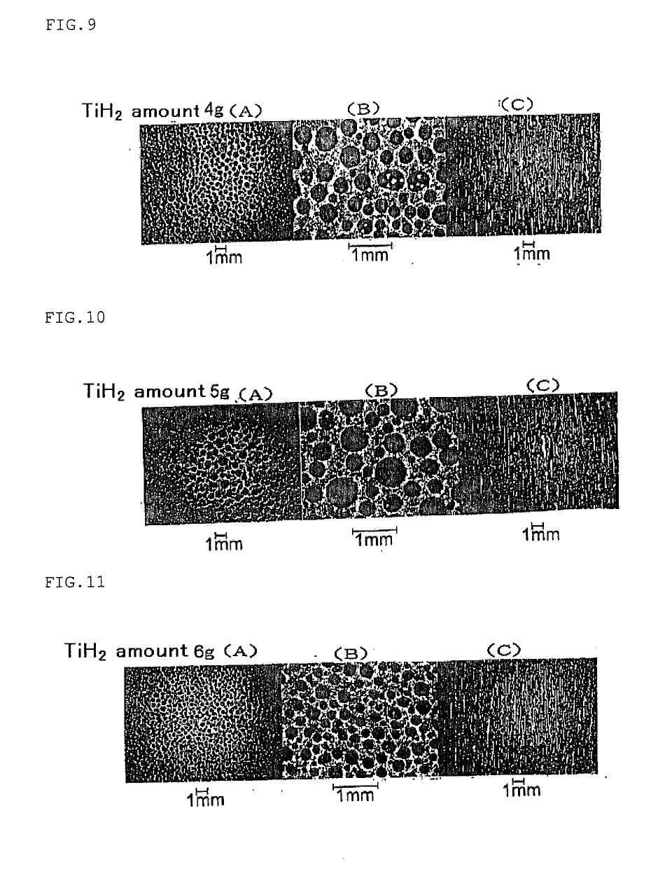

FIG. 9 shows optical microscope images of the obtained porous body. FIG. 9(A) is a microphotograph of the entire horizontal cross-section of the porous body; FIG. 9(B) is a partially magnified microphotograph of the horizontal cross-section; and FIG. 9 (C) is a microphotograph of a vertical cross-section of the porous body. The porosity and average pore size of the obtained porous body were 42% and 272±106 μm, respectively.

### Example 2

Another porous body was produced using the same method as that of Example 1, except that 5 g of titanium hydride was used with respect to 105 g of pure copper.

FIG. 10 shows optical microscope images of the obtained porous body. FIG. 10 (A) is a microphotograph of the entire horizontal cross-section of the porous body; FIG. 10(B) is a partially magnified microphotograph of the horizontal cross-section; and FIG. 10 (C) is a microphotograph of a vertical cross-section of the porous body. The porosity and average pore size of the obtained porous body were 45% and 290±154 μm, respectively.

### Example 3

Another porous body was produced using the same method as that of Example 1, except that 6 g of titanium hydride was used with respect to 105 g of pure copper.

FIG. 11 shows optical microscope images of the obtained porous body. FIG. 11 (A) is a microphotograph of the entire horizontal cross-section of the porous body; FIG. 11(B) is a partially magnified microphotograph of the horizontal cross-section; and FIG. 11 (C) is a microphotograph of a vertical cross-section of the porous body. The porosity and average pore size of the obtained porous body were 37% and 173±65 μm, respectively.

### Example 4

Another porous body was produced using the same method as that of Example 1, except that 8 g of titanium hydride was used with respect to 105 g of pure copper.

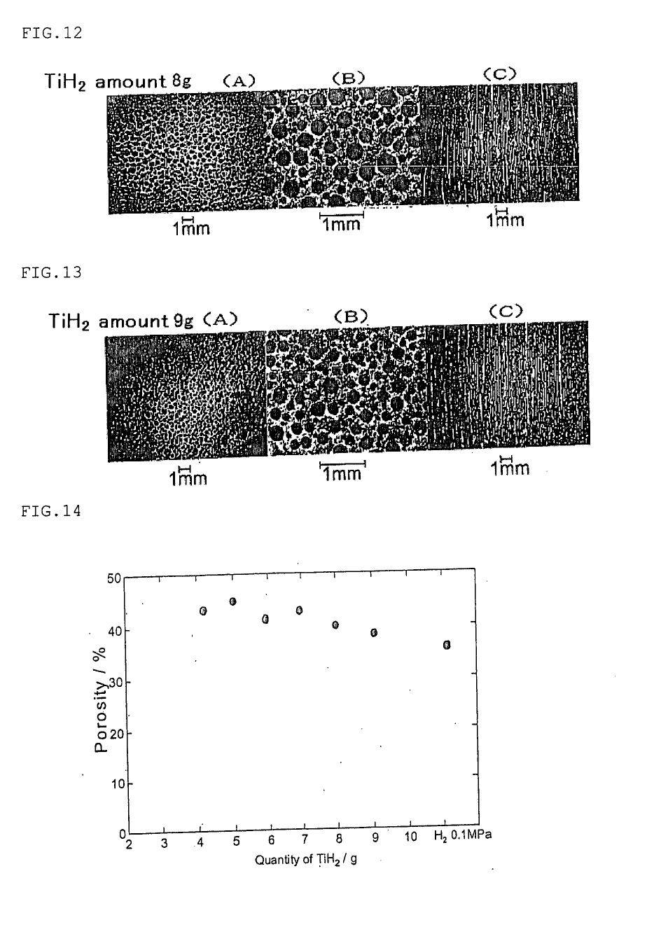

FIG. 12 shows optical microscope images of the obtained porous body. FIG. 12(A) is a microphotograph of the entire horizontal cross-section of the porous body; FIG. 12(B) is a partially magnified microphotograph of the horizontal cross-section; and FIG. 12 (C) is a microphotograph of a vertical cross-section of the porous body. The porosity and average pore size of the obtained porous body were 40% and 208±105 μm, respectively.

### Example 5

Another porous body was produced using the same method as that of Example 1, except that 9 g of titanium hydride was used with respect to 105 g of pure copper.

FIG. 13 shows optical microscope images of the obtained porous body. FIG. 13(A) is a microphotograph of the entire horizontal cross-section of the porous body; FIG. 13(B) is a partially magnified microphotograph of the horizontal cross-section; and FIG. 13 (C) is a microphotograph of a vertical cross-section of the porous body. The porosity and average pore size of the obtained porous body were 34% and 174±70 μm, respectively.

FIG. 14 is a graph showing a relationship between an amount of titanium hydride and the porosity, for each of the porous bodies obtained in Examples 1 to 5. As shown in FIG. 14, an increase in amount of the titanium hydride tends to slightly decrease the porosity. FIG. 15 is a graph showing a relationship between an addition amount of titanium hydride and a pore size, for each of the porous bodies obtained in Examples 1 to 5. As shown in FIG. 15, an increase in amount of the titanium hydride tends to slightly decrease the pore size.

FIG. 14 and FIG. 15 show that, in a porous body production method using the apparatus of FIG. 1 under 0.1 MPa argon atmosphere in which pure copper (99.99%) is used as a porous body-forming material and titanium hydride (TiH₂) is used as a gas-forming compound, the porosity and pore size of the resulting porous body can be controlled by adjusting the proportion of the titanium hydride (TiH₂) to the pure copper.

### Example 6

A copper porous body was produced using the same porous body production apparatus as that of Example 1, in the following manner.

200 g of pure copper (99.99%) was used as a porous body-forming material. This material was heated by a high-frequency induction heating coil in a crucible under 0.1 MPa argon atmosphere. Said material thus melted by heating was kept at 1,300° C.

Titanium hydride (TiH₂) was used as the gas-forming compound. The titanium hydride was formed into a 5 mm-diameter pellet, and placed on the bottom of a mold.

Then, the molten material was poured into the mold. The four samples were made by varying titanium hydride amounts, 0.075 g, 0.10 g, 0.125 g and 0.25 g.

Coolant water was supplied to the cooling unit so as to cool the molten raw material from the bottom of the mold. As a result, the molten raw material began to solidify from its bottom portion, and the fine reaction product, which was generated by the thermal decomposition of the titanium hydride, served as a gas bubble generating nuclei to generate gas bubbles. As such, unidirectional, uniform pores grew upward as the molten material was solidified, thereby forming a cylindrical copper porous separate body.

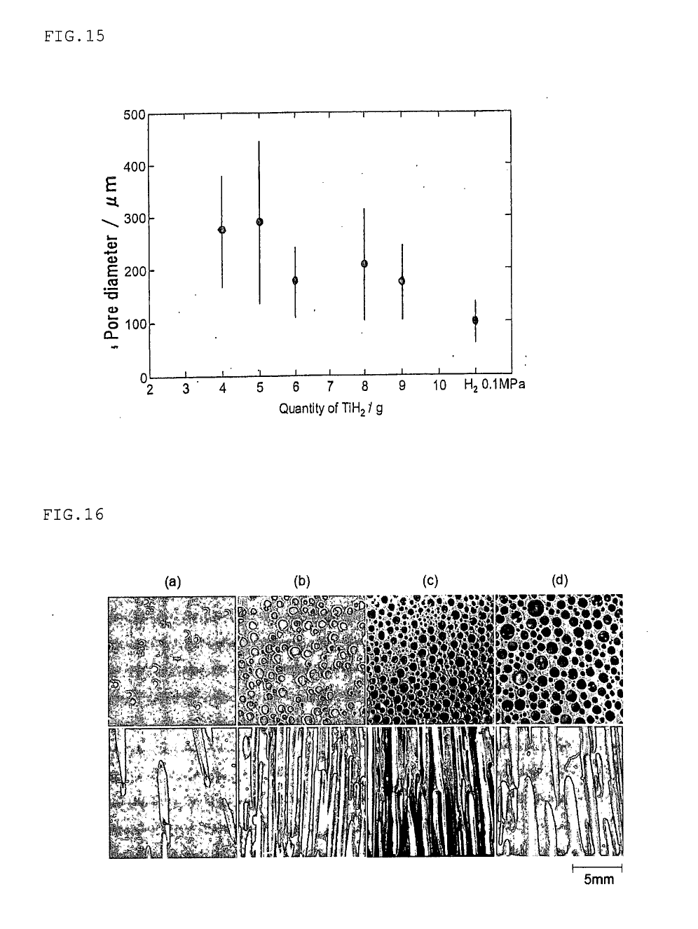

FIG. 16 shows optical microscope images of the obtained porous body. In the porous body (a) of FIG. 16, 0.075 g of titanium hydride was used; in the porous body (b), 0.10 g of titanium hydride was used; in the porous body (c), 0.125 g of titanium hydride was used; and in the porous body (d), 0.25 g of titanium hydride was used. In (a) to (d), the upper image is a partially magnified microphotograph of a horizontal cross-section of the porous body, and the lower image is a partially magnified microphotograph of a vertical cross-section of the porous body.

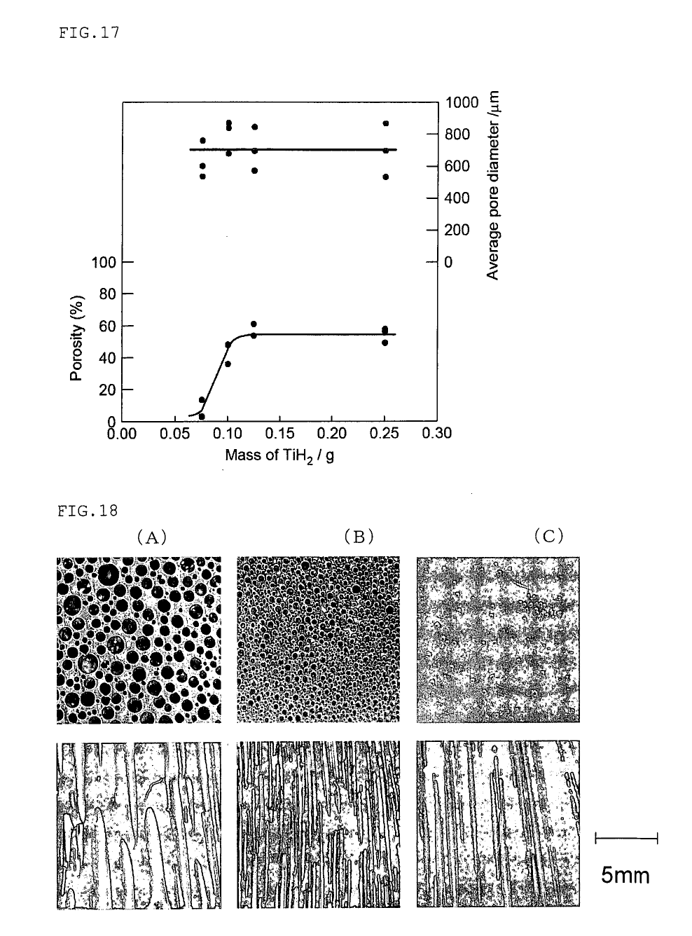

FIG. 17 is a graph showing the relationship between the amount of titanium hydride, and the pore size and the porosity, for the porous bodies obtained above. The pore size was nearly the same for all samples regardless of the amount of titanium hydride. The porosity increased as the amount of titanium hydride increased until the amount reaches 0.10 g; thereafter, the porosity became almost constant.

### Example 7

A copper porous body was produced using the same porous body production apparatus as that of Example 1, in the following manner.

200 g of pure copper (99.99%) was used as a porous body-forming material. The material was heated by the high-frequency induction heating coil in a crucible under argon atmosphere. The raw material thus melted by heating was kept at 1,300° C. Three samples were made by varying the pressure of argon: 0.1 MPa, 0.25 MPa and 0.5 MPa.

0.25 g of titanium hydride (TiH₂) was used as the gas-forming compound. The titanium hydride was formed into a 5 mm-diameter pellet, and placed on the bottom of a mold. Otherwise, the same process as that of Example 6 was used.

FIG. 18 shows optical microscope images of the obtained porous body. In the porous body (A) of FIG. 18, the pressure of argon was 0.1 MPa; in the porous body (B), the pressure of argon was 0.25 MPa; and in the porous body (C), the pressure of argon was 0.5 MPa. In (A) to (C), the upper image is a partially magnified microphotograph of a horizontal cross-section of the porous body, and the lower image is a partially magnified microphotograph of a vertical cross-section of the porous body.

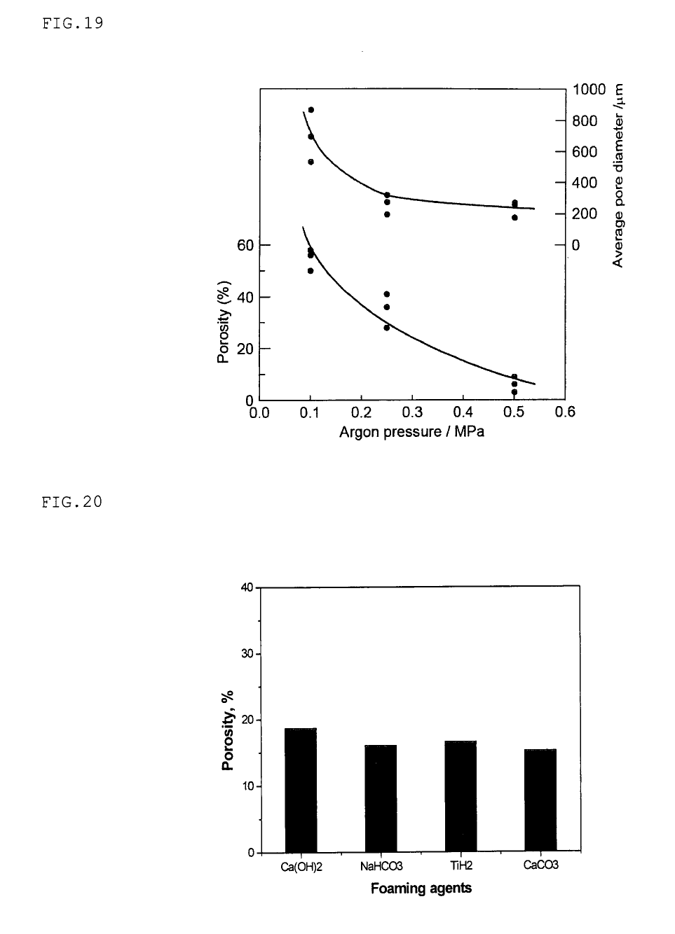

FIG. 19 is a graph showing the relationship between the pressure of argon gas, and the porosity and pore size, for the porous bodies obtained above. The porosity and the pore size both tend to decrease with an increase of argon gas pressure.

### Example 8

An aluminum porous body was produced using the same porous body production apparatus as that of Example 1, in the following manner.

50 g of pure aluminum was used as a porous body-forming material. The material was heated by a high-frequency induction heating coil in a crucible under reduced pressure of 0.1 Pa. The material thus melted by heating was kept at 750° C.

As a gas-forming compound, Ca(OH)₂, NaHCO₃, TiH₂, or CaCO₃ was used in an amount of 0.2 g. The compound in the form of powder was placed on the bottom of a mold.

Next, the molten material was poured into the mold, and coolant water was supplied to the cooling unit 10 so as to cool the molten material from the bottom of the mold. As a result, the molten material started to solidify from its bottom portion, and unidirectional, uniform pores grew upward as the molten raw material was solidified, thereby forming a cylindrical aluminum porous separate body.

FIG. 20 is a graph showing the porosity of the obtained aluminum porous body for each of the gas-forming compounds. The porosity was around 20% for all of the four gas-forming compounds; that is, the porosity was almost constant. However, the shape of the pores varied depending on the gas-forming compound used. The cause of the difference in shape is not clearly understood, but presumably derives from the difference in the generated gases.

### Example 9

Using a floating zone melting method, an iron porous body was produced as follows.

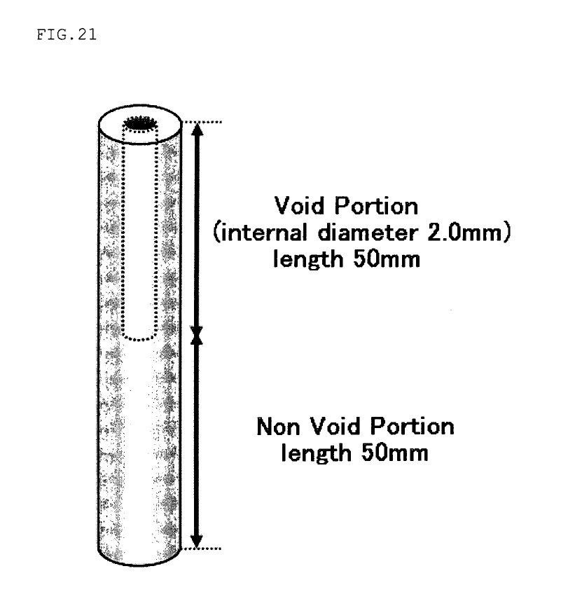

As a raw material, an cylindrical iron (purity=99.5%) rod 10 mm in external diameter and 100 mm in total length was used. As shown in FIG. 21, a void 50 mm in length and 2 mm in internal diameter was formed in the core of the rod.

CrN (N=18 wt %) was used as a gas-forming compound, and the void portion of the iron rod was filled with about 0.45 g of CrN in powder form.

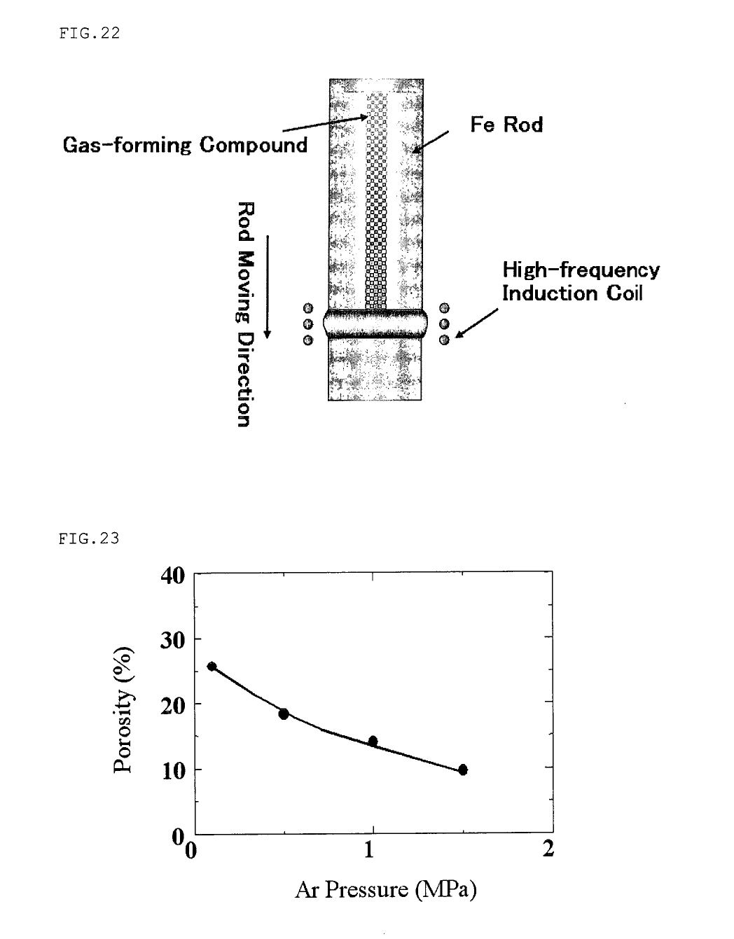

As shown in FIG. 22, under 0.5 MPa He gas atmosphere, the rod was moved downward in the vertical direction at a rate of 330 μm/sec. The rod was heated and partially melted using a high-frequency coil. The molten portion was sequentially solidified to produce a porous body.

The obtained porous body has pores extending substantially in parallel with the moving direction. The porosity and average pore size of the porous body were 28% and 550 μm, respectively.

### Example 10

An magnesium porous body was produced using the same porous body production apparatus as that of Example 1, in the following manner.

50 g of pure magnesium (99.99%) was used as a porous body-forming material. The material was heated in a crucible using a high-frequency induction heating coil under 0.1 MPa argon atmosphere. The material thus melted by heating was kept at 850° C. for 30 seconds.

As a gas-forming compound, 0.5 g of MgH₂ powder was used. The powder was placed on the bottom of a mold.

Next, the molten material was poured into the mold, and coolant water was supplied to the cooling unit so as to cool the molten material from the bottom of the mold. As a result, the molten material began to solidify from its bottom portion, and unidirectional, uniform pores grew upward as the molten raw material was solidified, thereby forming a cylindrical magnesium porous separate body.

The porosity and average pore size of the obtained porous body were 29% and 470 μm, respectively.

### Example 11

A porous body was produced in the same manner as that of Example 10, except that a magnesium alloy (AZ31D) was used as a raw material.

The porosity and average pore size of the obtained porous body were 37% and 614 μm, respectively.

### Example 12

A Si porous body was produced using the same porous body production apparatus as that of Example 1, in the following manner.

18 g of Si was used as a porous body-forming material. The raw material was heated and melted in a crucible by a high-frequency induction heating coil under argon gas atmosphere, and kept at 1,450° C. Three levels of pressure were used on the argon gas introduction: 0.5 MPa (0.8 MPa upon casting), 1.0 MPa (1.5 MPa upon casting), and 1.5 MPa (2.1 MPa upon casting).

As a gas-forming compound, 1 g of titanium hydride (TiH₂) powder was used. The powder was placed on the bottom of a mold.

Next, the molten material was poured into the mold. As a result, the titanium hydride (TiH₂) placed on the bottom of the mold was diffused to the molten material, thereby generating hydrogen gas, most of which was dissociated into hydrogen ion or atoms.

Coolant water was supplied to the cooling unit so as to cool the molten material from the bottom of the mold. As a result, the molten material began to solidify from its bottom portion, and unidirectional, uniform pores grew upward as the molten material was solidified, thereby forming a cylindrical Si porous separate body.

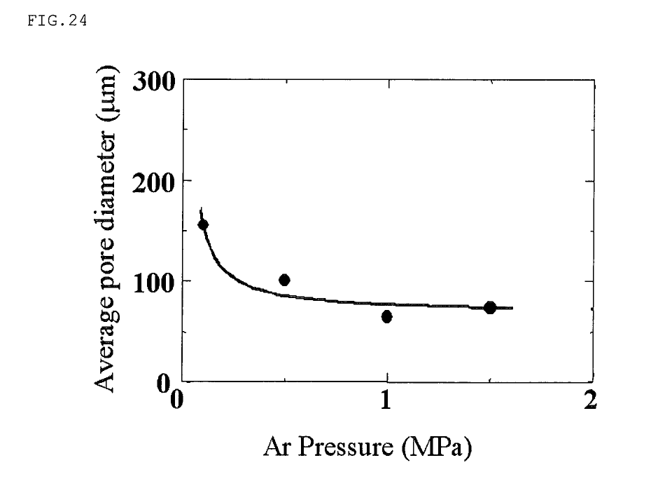

FIG. 23 is a graph showing the relationship between pressure of argon gas and porosity, for the porous bodies obtained above. FIG. 24 is a graph showing the relationship between the pressure of argon gas and the pore size. The porosity and pore size both tend to decrease with an increase in the argon gas pressure. However, the pore size becomes substantially constant when the pressure increases.

1. A process for producing a porous body, comprising dispersing a gas-forming compound in a molten porous body-forming material, and then solidifying the molten material.

2. The process according to claim 1, wherein the porous body-forming material has a gas solubility that is smaller in a solid phase than in a liquid phase.

3. The process according to claim 2, wherein the porous body-forming material is magnesium, aluminum, titanium, chromium, manganese, iron, cobalt, nickel, copper, zirconium, molybdenum, palladium, silver, hafnium, tungsten, tantalum, platinum, gold, lead, uranium, beryllium, an alloy containing at least one member of the foregoing metals, an intermetallic compound containing at least one member of the foregoing metals, silicon, or germanium.

4. The process according to claim 1, wherein the gas-forming compound is a compound which generates by thermal decomposition at least one kind of gas selected from the group consisting of hydrogen, nitrogen, oxygen, H₂O, carbon monoxide, and carbon dioxide.

5. The process according to claim 1, wherein the gas-forming compound is at least one compound selected from the group consisting of TiH₂, MgH₂, ZrH₂, Fe₄N, TiN, Mn₄N, CrN, Mo₂N, Ca(OH)₂, Cu₂O, B₂O₃, CaCO₃, SrCO₃, MgCO₃, BaCO₃ and NaHCO₃.

6. The process according to claim 1, wherein the gas-forming compound is added to the molten porous body-forming material by adding the gas-forming compound to the molten material; supplying the gas-forming compound in a container for the molten material beforehand; supplying the gas-forming compound in a mold beforehand; or supplying the gas-forming compound to the porous body-forming material before the material is melted.

7. The process according to claim 1, wherein a porous body is produced using a mold casting method, a continuous casting method, a floating zone melting method, or a laser•arc beam melting method.

8. The process according to claim 1, wherein, before the porous body-forming material is melted, the material is degassed by being retained in an airtight container under reduced pressure at a temperature less than a melting point of the material.

9. A porous body produced by the process of claim 1.
